(19) United States
(12) Patent Application Publication
(10) Pub. No.: US 2014/0284393 A1
(43) Pub. Date: Sep. 25, 2014

(54) ELECTROSTATIC GUN AND METHOD FOR GROUNDING AN ELECTROSTATIC GUN AFTER DISCHARGING STATIC CHARGES

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: TEN-CHEN HO, New Taipei (TW); YONG-SHENG YANG, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/096,021

(22) Filed: Dec. 4, 2013

(30) Foreign Application Priority Data
Mar. 20, 2013 (CN) 2013100896166

(51) Int. Cl. B05B 5/025

(52) U.S. Cl. CPC B05B 5/025
USPC 239/3; 239/690

(57) ABSTRACT

An electrostatic gun includes an electrostatic nozzle, a toggle switch, an electrostatic discharge module, an electrostatic generator module, and a ground module. The electrostatic generator module is connected to the electrostatic discharge module to generate static. The toggle switch is used to connect the electrostatic nozzle to either the electrostatic discharge module or the ground module.

### BACKGROUND

1. Technical Field

The present disclosure relates to an electrostatic gun and method for grounding the electrostatic gun after discharging static charges.

2. Description of Related Art

Typically, after an electrostatic gun is used on a device without a connection to ground, the device should be grounded immediately to discharge the static to prevent an accumulation of static which affects test results or causing an electric shock to the user.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of an electrostatic gun of the present disclosure.

FIG. 2 is a flowchart of a method for grounding the electrostatic gun after discharging static charges in the embodiment of FIG. 1.

### DETAILED DESCRIPTION

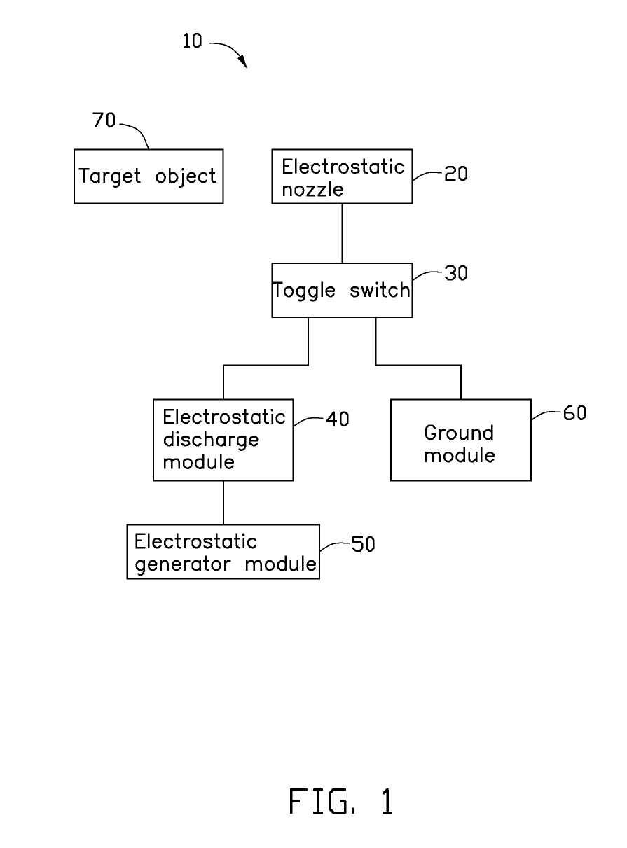

FIG. 1 shows an embodiment of an electrostatic gun 10 of the present disclosure.

The electrostatic gun 10 includes an electrostatic nozzle 20, a toggle switch 30, an electrostatic discharge module 40, an electrostatic generator module 50, and a ground module 60. The electrostatic nozzle 20 is connected to the toggle switch 30. The electrostatic generator module 50 is connected to the toggle switch 30 through the electrostatic discharge module 40. The toggle switch 30 is grounded through the ground module 60.

The toggle switch 30 can be a single-pole double-throw switch. The ground module 60 can be a resistor connected to ground. The pole of the toggle switch 30 is connected to the electrostatic nozzle 20. A first throw of the toggle switch 30 is connected to the ground module 60. A second throw of the toggle switch 30 is connected to the electrostatic discharge module 40. The toggle switch 30 defaults to connect the electrostatic nozzle 20 to the ground module 60. Static charges generated by the electrostatic generator module 50 are transmitted to the electrostatic discharge module 40. When the toggle switch 30 connects the electrostatic nozzle 20 to the electrostatic discharge module 40, the electrostatic discharge module 40 sprays the static charges from the electrostatic generator module 50 to a target object 70 through the electrostatic nozzle 20.

Static charges may remain on a surface of the target object 70 after the spraying. When the toggle switch 30 connects the electrostatic nozzle 20 to the ground module 60, the remaining static charges could be discharged to ground by connecting the electrostatic nozzle 20 to the target object 70. The electrostatic gun 10 discharges static and also can act as ground, depending on the throw of the switch.

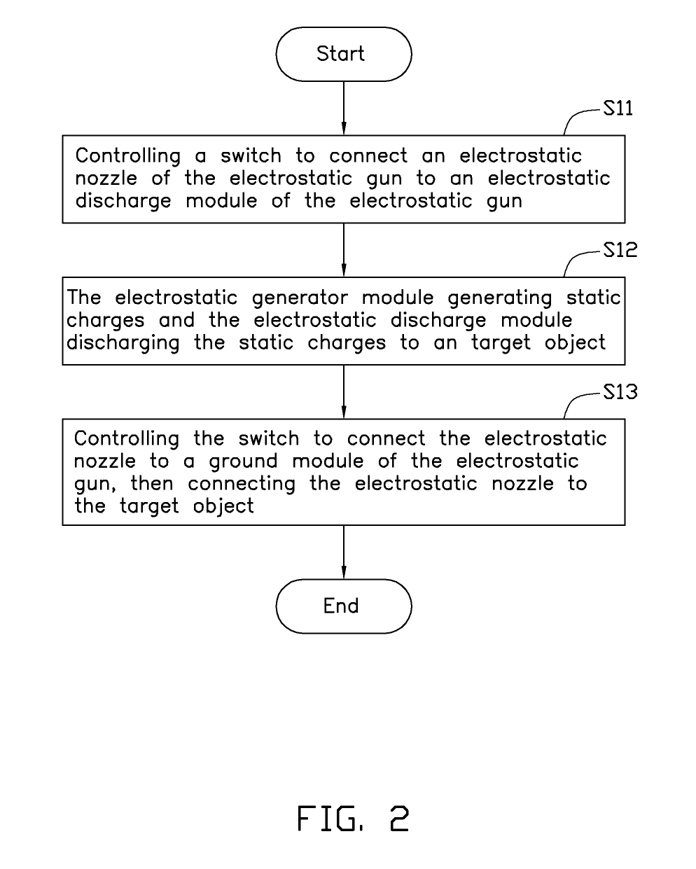

FIG. 2 illustrates a flowchart of a method for grounding the electrostatic gun 10 after discharging static charges in the embodiment of FIG. 1

In block S11, the toggle switch 30 connects the electrostatic nozzle 20 of the electrostatic gun 10 to an electrostatic discharge module 40 of the electrostatic gun 10.

In block S12, the electrostatic generator module 50 generates static charges and the electrostatic discharge module 40 discharges the static charges to the target object 70.

In block S13, the toggle switch 30 connects the electrostatic nozzle 20 to a ground module 60 of the electrostatic gun 10 and connects the electrostatic nozzle 20 to the target object 70.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An electrostatic gun, comprising:
an electrostatic nozzle;
a switch;
an electrostatic discharge module;
an electrostatic generator module connected to the electrostatic discharge module to generate static charges; and
a ground module connected to the switch, wherein the switch is operable of connecting the electrostatic nozzle to either the electrostatic discharge module or the ground module.

2. The electrostatic gun of claim 1, wherein the ground module is a resistor connected to ground.

3. The electrostatic gun of claim 1, wherein the switch is a single-pole double-throw switch.

4. The electrostatic gun of claim 3, wherein a first throw of the switch is connected to the ground module, and a second throw of the switch is connected to the electrostatic discharge module.

5. A method for grounding an electrostatic gun after discharging static charges, the method comprising:
starting the electrostatic gun, and controlling a switch to connect an electrostatic nozzle of the electrostatic gun to an electrostatic discharge module of the electrostatic gun;
the electrostatic generator module generating static charges and the electrostatic discharge module discharging the static charges to an target object;
controlling the switch to connect the electrostatic nozzle to a ground module of the electrostatic gun, then connecting the electrostatic nozzle to the target object to ground the target object.
